(19) United States
(12) Patent Application Publication
(10) Pub. No.: US 2018/0003996 A1
(43) Pub. Date: Jan. 4, 2018

(54) 3D Labels

(71) Applicant: Joseph Reginelli, Paducah, KY (US)

(72) Inventor: Joseph Reginelli, Paducah, KY (US)

(21) Appl. No.: 15/640,440

(22) Filed: Jun. 30, 2017

Related U.S. Application Data
(60) Provisional application No. 62/357,783, filed on Jul. 1, 2016.

(51) Int. Cl. G02B 27/22; B44F 1/06; B65D 23/08; G09F 23/00

(52) U.S. Cl. CPC G02B 27/2221; G09F 23/00; A47G 2200/08; B44F 1/066; B65D 23/085

(57) ABSTRACT

The invention is an outer layer obscuring an image on a base layer on a receptacle. When illuminated, the obscured image or images are revealed. The base layer is disposed on the exterior wall of the receptacle. The base layer has an image. The outer layer is disposed on the first layer and it can also include an image but it can be without any image at all. The outer layer obscures the first layer. An illuminating source is placed inside the wall of the receptacle. When illuminated, the first image on the base layer is visible through the outer layer. The second image of the outer layer can be observed to form a new combined image with the first image of the base layer.

### CROSS REFERENCE TO RELATED APPLICATIONS

This application claims the benefit of U.S. Provisional Application Ser. No. 62/357,783 filed by Reginelli on Jul. 1, 2016 and entitled “3D Labels”, which is incorporated herein by reference.

### FIELD OF INVENTION

The invention relates to layers disposed on a receptacle with an illuminating source. A layer can conceal one or more layers that are only revealed when the illuminating source is in the on position. The layers also can be combined in a way that gives a three-dimensional effect when illuminated.

### BACKGROUND OF THE INVENTION

Typically only one layer is illuminated at a time. The prior art shows that an image can be illuminated through the use of mirrors or having a transparent section to show an image on the inside of the back of an object.

### SUMMARY OF THE INVENTION

The present invention is where one layer obscures an image on another layer on a receptacle. When illuminated, the obscured images are revealed. The receptacle can be any container or even a container without a bottom. The container can be any shape. The base layer is disposed on the exterior wall of the receptacle. The base layer has an image. The outer layer is disposed on the first layer and it can also include an image but it can be without any image at all. The outer layer obscures the first layer. An illuminating source is placed inside the wall of the receptacle. When illuminated, the first image on the base layer is visible through the outer layer. The second image of the outer layer can be observed to form a new combined image with the first image of the base layer.

### BRIEF DESCRIPTION OF DRAWINGS

FIG. 1 is a front view of a receptacle with an illuminating source, an outer layer, and a base layer with an image.

FIG. 2 is a front view of a receptacle showing the outer layer with the illuminating source not on.

FIG. 3 is a front view of a receptacle showing the base layer an image with the illuminating source on.

FIG. 4 is a flow chart describing the method of the current invention.

### DETAILED DESCRIPTION OF THE INVENTION

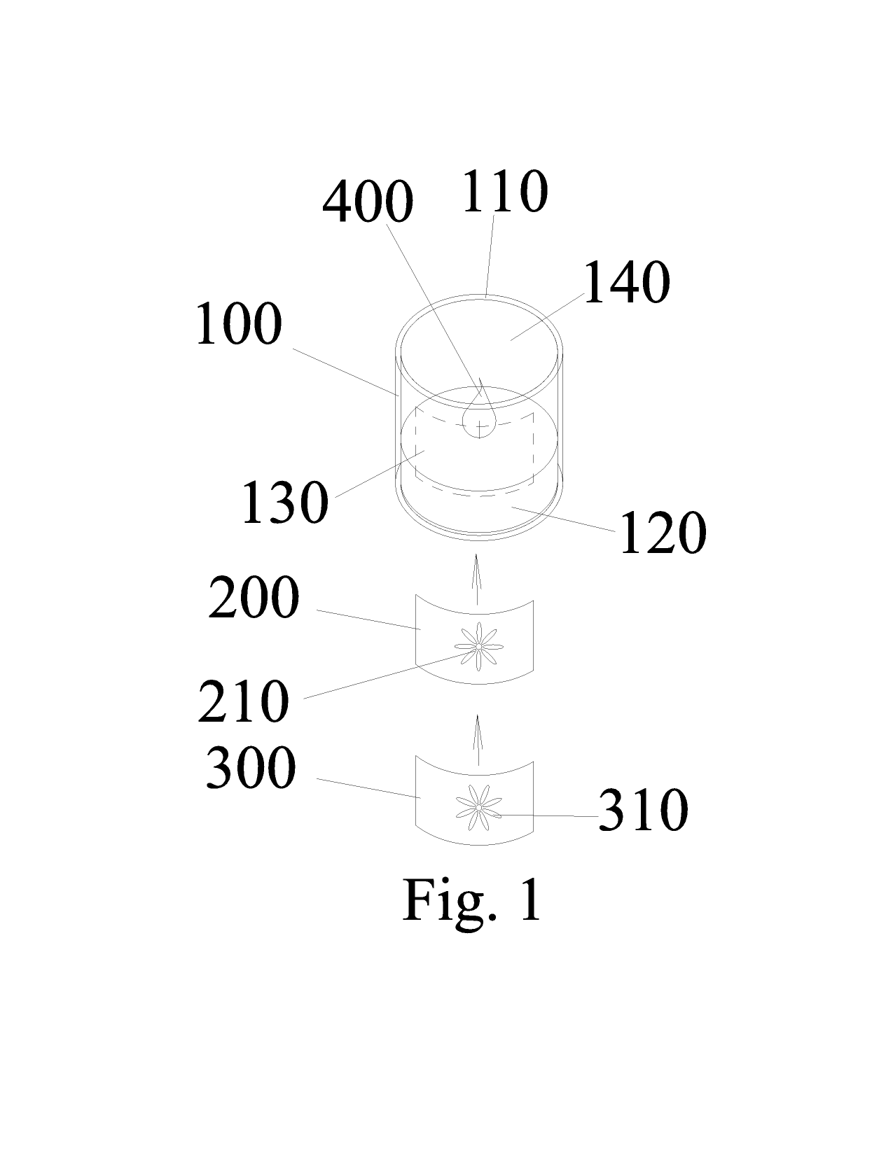

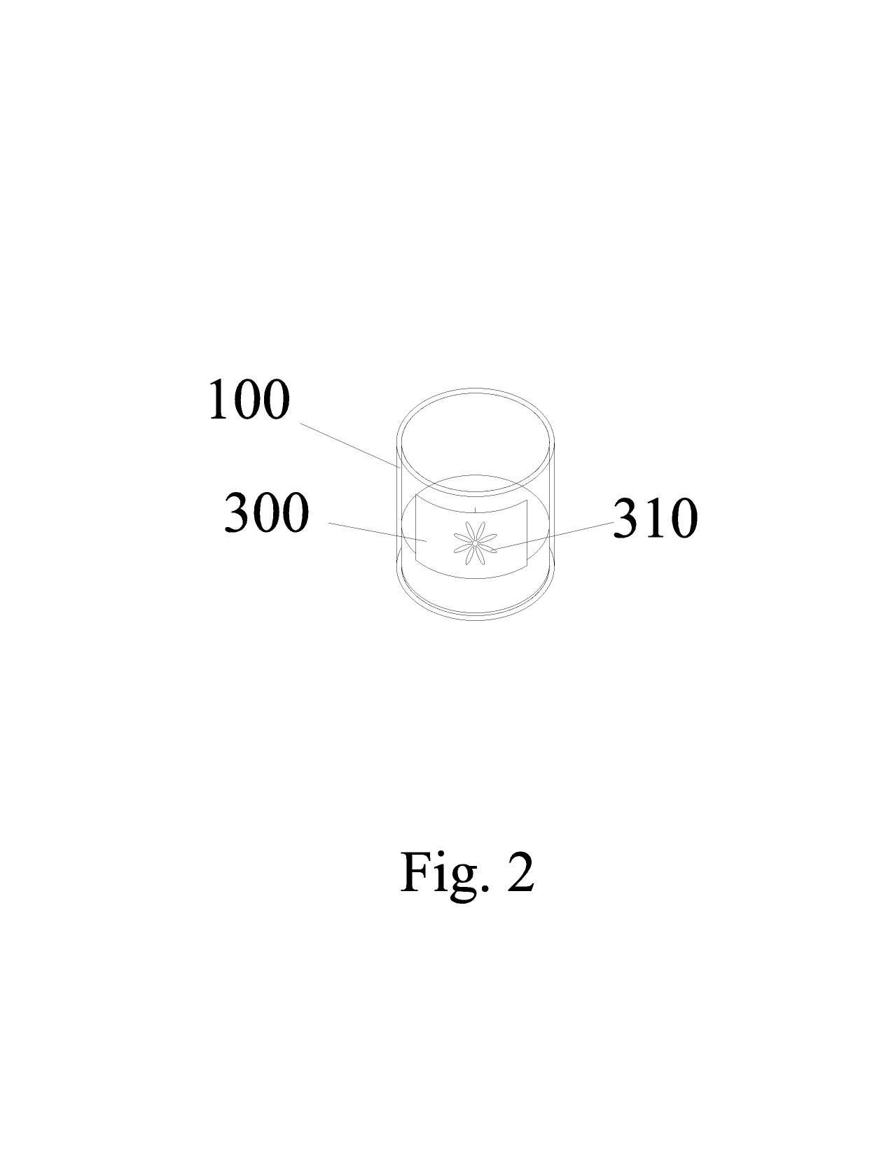

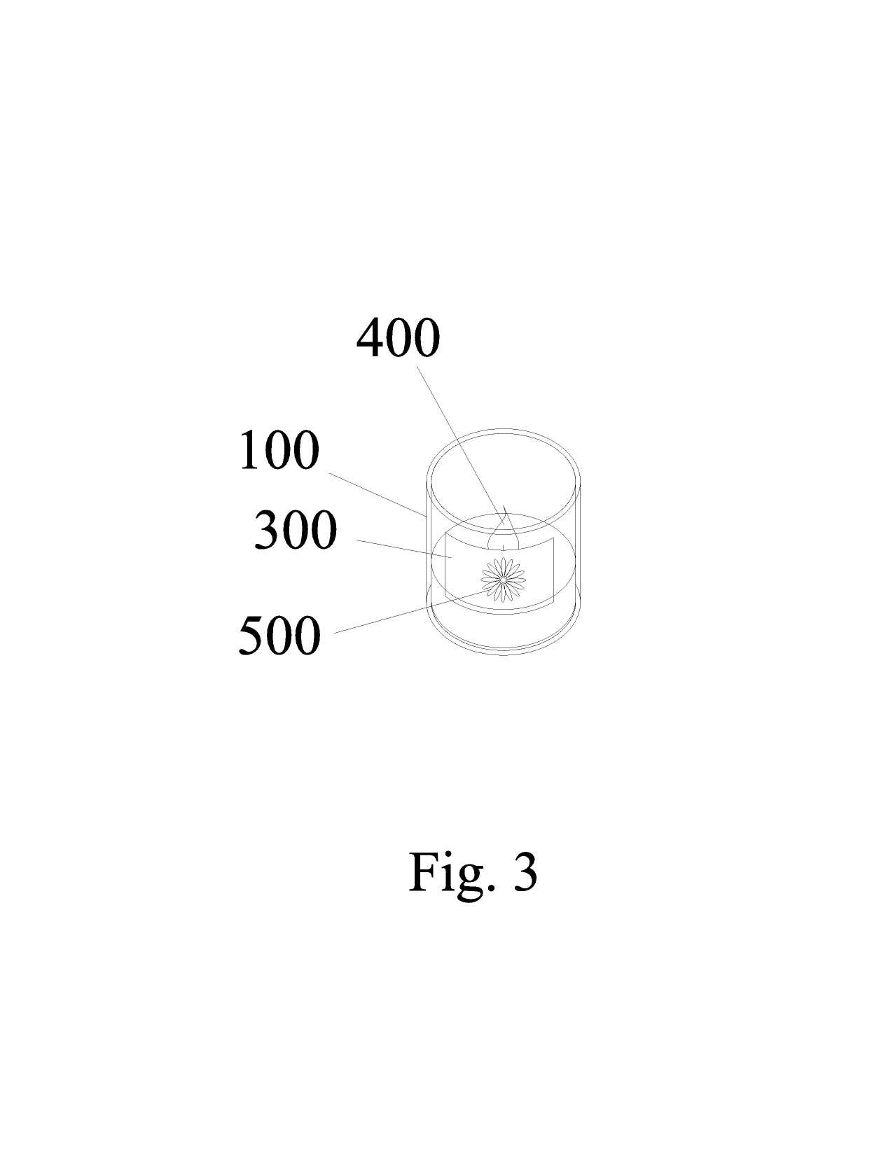

A receptacle 100 can have a wall 110. The wall 110 can be any shape including but not limited to tubular or flat. The wall 110 may be only semi-circular with a base on the bottom. The wall has an interior surface 140 and exterior surface 120. The disposition spot 130 can be any place on an exterior surface 120. The wall 110 can be transparent or translucent. A base layer 200 including a first image 210 is disposed on the exterior surface 120 of the wall 110 in FIG. 1. An outer layer 300 including a second image 310 is disposed on the base layer 200 obscuring the first image 210. The outer layer 300 is obscuring the base layer 200 on the receptacle in FIG. 2. In FIG. 3, the illuminating source 400 is on inside the receptacle 100. The first image 210 on the base layer 200 is now visible through the outer layer 300 with the second image 310. The first image 210 and the second image 310 combine to form a totally new combined image 500.

In the example shown in the Figures, the first image 210 has eight petals pointing in the directions of a compass if the top of the paper is North. The second image 310 has eight petals in between the petals shown on the first image 210. The first image 210 is combined with the second image 310 to form a sixteen petal flower in the combine image 500. Any image may be used here to offset from another image including houses, gazebos, buildings, trees, foliage. The offset gives the image a three-dimensional effect.

The present invention may combine multiple layers and multiple images. When illuminated, the multiple images will combine to give a three-dimensional effect. The three-dimensional effect gives the objects the appearance of depth as well as length and width already present.

The illuminating source 400 can be flickering or solid state. The illuminating source 400 can be battery-operated, plugged in with a wire, or lit with fire. The illuminating source 400 may be a battery operated or corded light bulb. The bulb can be a light emitting diode, compact fluorescent, incandescent, or halogen. If the illuminating source 400 is a candle the wick, when lit with fire, creates the light and creates the unique effect. The more the wick burns down the first image 210 is more visible. If the room is dimmer, the first image 210 is more visible. The first image 210 and the second image 310 can also be words or symbols. The illuminating source 400 shines from inside the interior surface 140 through a transparent or translucent wall 110.

The base layer 200 and outer layer 300 can be a label made of any type of polymer, fiber, or paper. The base layer 200 and outer layer 300 can be made of paint or any other material that can be layered. An adhesive can be applied to the base layer 200 and outer layer 300 to make sure that the base layer 200 and outer layer 300 will adhere to the exterior surface of the wall and to each other. The base layer 200 and the outer layer 300 can have coatings of a different material such as a paper material with a plastic or polymer coating. The material of the base layer 200 and outer layer 300 can be clingy or heat applied without a separate adhesive like a laminate. The base layer 200 and outer layer 300 can be any shape including but not limited to rectangular, square, circular, triangular, or any other polygon. The thickness of the base layer 200 and outer layer 300 can be a standard label or paper thickness but also may be thicker or thinner as necessary to get both an obscuring and an illumination of the first image 210.

The image 210 can be anything that can be mechanically printed or hand-drawn. The use of color or the absence of color can be used to compose the image. Certain color combinations will work better than others. The outer layer 300 does not have to be completely opaque but must be able to obscure, i.e. hide some part of, the image 210 so that it is not totally visible when the illuminating source 400 is not present or not in the on position.

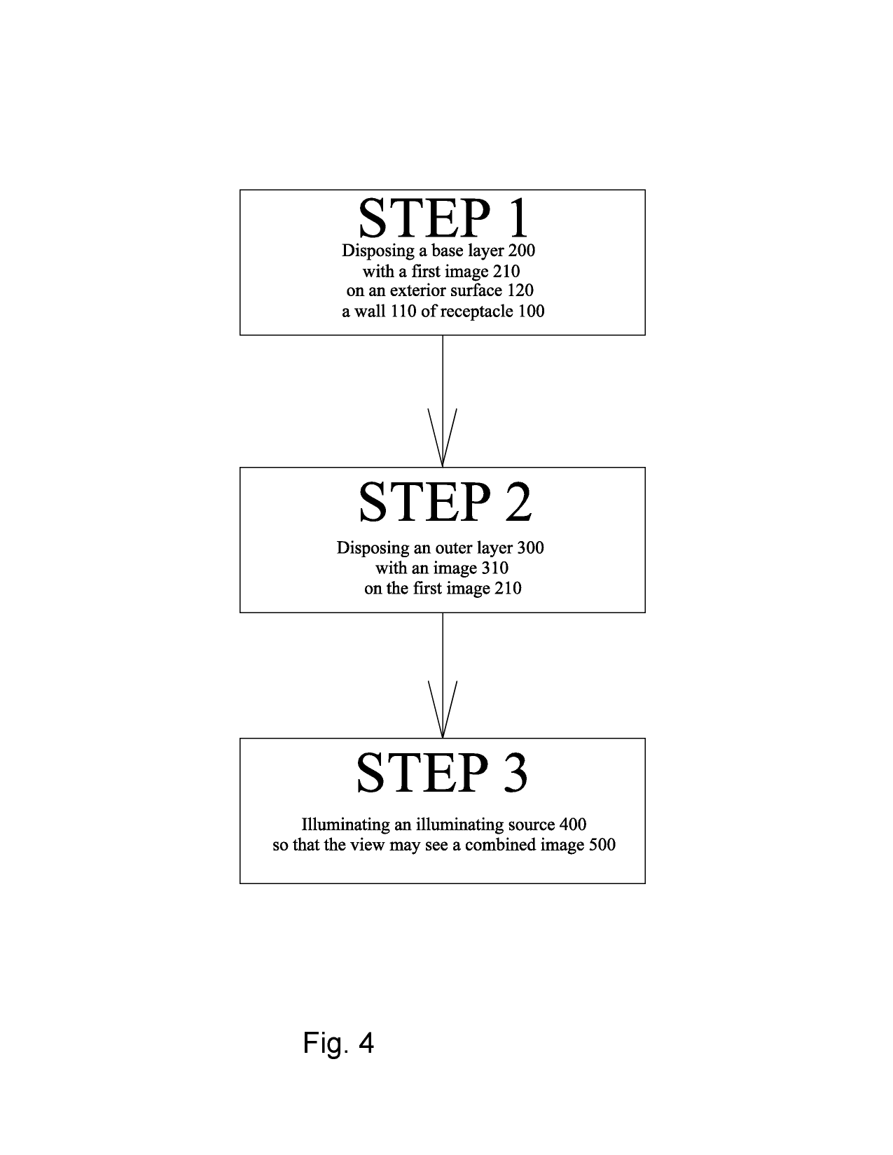

The method of illuminating multiple layers requires the following steps in FIG. 4. Step one would be disposing a base layer 200 with a first image 210 on an exterior surface 120 a wall 110 of a receptacle 100. The second step is disposing an outer layer 300 with an image 310 on the first image 210. The third step is illuminating an illuminating source 400 so that the view may see or viewer may see a combined image 500.

The first image 210 can be obscured prior to illumination. Even when illuminated, the entire first image 210 does not have to be fully visible.

I claim:

1. A system comprising:
a receptacle that includes a wall, wherein the wall comprises an interior surface and an exterior surface;
a base layer disposed on the wall, where the base layer includes an image;
an outer layer disposed on the base layer such that the image is obscured when externally viewed; and
an illuminating source within the receptacle such that when the illuminating source is in the receptacle the image is externally visible through the outer layer.

2. The system in claim 1, wherein the illuminating source is flickering.

3. The system in claim 1, wherein the base layer and the outer layer has one surface that is an adhesive.

4. The system in claim 1, wherein the wall is tubular.

5. A system comprising:
a receptacle that includes a top, wherein the top comprises an interior surface and an exterior surface;
a base layer disposed on the top, where the base layer includes an image;
an outer layer disposed on the base layer such that the image is obscured when externally viewed; and
an illuminating source within the receptacle such that when the illuminating source is in the receptacle the image is externally visible through the outer layer.

6. The system in claim 5, wherein the illuminating source is flickering.

7. The system in claim 5, wherein the base layer and the outer layer has one surface that is an adhesive.

8. The system in claim 5, wherein the wall is tubular.

9. A method comprising:
Disposing a base layer, which includes an image, on a receptacle; and then disposing an outer layer on the base layer such that the image is obscured.

10. The method in claim 9, wherein the base layer and the outer layer has one surface that is an adhesive.
